(19) United States
(12) Patent Application Publication
(10) Pub. No.: US 2009/0150497 A1
(43) Pub. Date: Jun. 11, 2009

(54) ELECTRONIC MAIL MESSAGE HANDLING AND PRESENTATION METHODS AND SYSTEMS

(76) Inventors: Randolph Preston McAfee, San Marino, CA (US); Shanmugasundaram Ravikumar, Berkeley, CA (US); Andrew Tomkins, San Jose, CA (US)

Correspondence Address: BERKELEY LAW & TECHNOLOGY GROUP LLP, 17933 NW EVERGREEN PARKWAY, SUITE 250, BEAVERTON, OR, 97006, US

(21) Appl. No.: 11/951,727

(22) Filed: Dec. 6, 2007

(51) Int. Cl. G06F 15/16

(52) U.S. Cl. 709/206

(57) ABSTRACT

Methods and apparatuses are provided for use with electronic mail messages. In one exemplary method, electronic mail messages may be presented in an order based, at least in part, on a presentation scores associated with each message. The presentation score may be based, at least in part, on presentation knowledge information associated with an attribute profile. The attribute profile may, for example, be established and maintained based, at least in part, on non-selective user engagement parameters that may be determined based on a presentation of the electronic mail messages and/or identifiers associated therewith.

### BACKGROUND

1. Field

The subject matter disclosed herein relates to data processing, and more particularly to electronic mail message handling and/or processing methods and systems.

2. Information

Computer network based electronic mail message systems are ubiquitous. Electronic mail messages, for example, associated with a folder or mailbox, may be presented to a user as a list of selectable identifiers. Such a list may be presented in a table that can be selectively sorted. For example a list of identifiers may be sorted to present a particular order, for example, based on sender, receiver, subject, or date.

A folder or other like logical/graphical arrangement may be provided for electronic mail messages that share one or more common attributes. For example, electronic mail messages may be classified or otherwise identified as received, sent, read, printed, forwarded, quarantined, etc.

Some electronic mail messages may be classified as “spam messages” and placed in a spam or junk message folder. Such spam messages may be quarantined or otherwise separated from and/or handled in a specific manner. For example, spam messages that remain in a junk message folder for a threshold period of time may be automatically deleted. Unfortunately, some messages that may not be considered to be “spam” by the user may nevertheless be classified and handled as spam messages by a messaging system. As a result, some users may review a list of spam messages to make sure that messages of potential interest to them are not missed.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a block diagram illustrating an exemplary computing environment system, in accordance with one aspect, having one or more computing platform devices adaptable to process and/or handle electronic mail messages.

FIG. 2 is a block diagram illustrating exemplary functions/features of an electronic mail message processing system that may, for example, be implemented using one or more devices such as shown in FIG. 1.

FIG. 3 is a flow diagram illustrating an exemplary method for processing and/or handling electronic mail messages that may, for example, be implemented using one or more devices such as shown in FIG. 1.

### DETAILED DESCRIPTION

Methods and systems are presented herein, which allow for improved processing and/or handling of electronic mail messages, and in particular electronic mail messages classified as having a common attribute. Spam messages are one example of such electronic mail messages.

In the exemplary methods and systems herein, electronic mail messages may be presented in an order based, at least in part, on a presentation scores associated with each message. The presentation score may be based, at least in part, on presentation knowledge information associated with an attribute profile. The attribute profile may, for example, be established and maintained based, at least in part, on user selective inputs and/or non-selective user engagement parameters that may be determined based on earlier and/or other (e.g., remote) presentation(s) of these or similar messages and/or message identifiers. Thus, for example, the user's potential interest and/or disinterest with regard to the messages may be learned and/or otherwise used to affect the order and/or manner in which such messages and/or other like messages are handled and/or presented to the user.

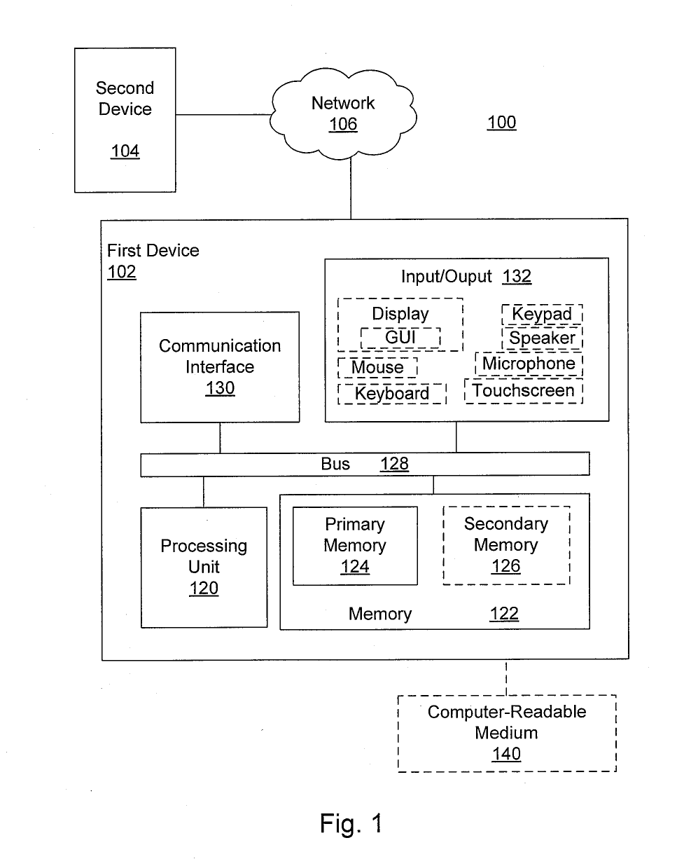

Attention is now drawn to FIG. 1, which is a block diagram illustrating an exemplary implementation of a computing environment system 100 having a first device 102 and a second device 104, which may be operatively coupled together using a network 106.

First device 102 and second device 104, as shown in FIG. 1, are each representative of any device, appliance or machine that may be configurable to exchange data over network 106. By way of example but not limitation, any of these devices may include: one or more computing devices or platforms, such as, e.g., a desktop computer, a laptop computer, a workstation, a server device, a client, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet based service provider/system, a portal and/or search engine service provider/system, a wireless communication service provider/system; and/or any combination thereof.

Network 106, as shown in FIG. 1, is representative of one or more communication links, processes, and/or resources configurable to support the exchange of data between at least first device 102 and second device 104. By way of example but not limitation, network 106 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It is recognized that all or part of the various devices and networks shown in system 100, and the processes and methods as further described herein, may be implemented using or otherwise include hardware, firmware, software, or any combination thereof. Additionally, the processes and methods as further described herein may be implemented in a distributed manner across a plurality of processing units and/or devices.

By way of example but not limitation, first device 102 may include at least one processing unit 120 that is operatively coupled to a memory 122 through a bus 128.

Processing unit 120 is representative of one or more circuits configurable to perform at least a portion of a data computing procedure or process. By way of example but not limitation, processing unit 120 may include one or more processors, controllers, microprocessors, microcontrollers, application specific integrated circuits, digital signal processors, programmable logic devices, field programmable gate arrays, and the like, or any combination thereof.

Memory 122 is representative of any data storage mechanism. Memory 122 may include, for example, a primary memory 124 and/or a secondary memory 126. Primary memory 124 may include, for example, a random access memory, read only memory, etc. While illustrated in this example as being separate from processing unit 120, it should be understood that all or part of primary memory 124 may be provided within or otherwise co-located/coupled with processing unit 120.

Secondary memory 126 may include, for example, the same or similar type of memory as primary memory and/or one or more data storage devices or systems, such as, for example, a disk drive, an optical disc drive, a tape drive, a solid state memory drive, etc. In certain implementations, secondary memory 126 may be operatively receptive of, or otherwise configurable to couple to, a computer-readable medium 140. Computer-readable medium 140 may include, for example, any medium that can carry and/or make accessible data, code and/or instructions for one or more of the devices in system 100.

First device 102 may include, for example, a communication interface 130 that provides for or otherwise supports the operative coupling of first device 102 to at least network 106. By way of example but not limitation, communication interface 130 may include a network interface device or card, a modem, a router, a switch, a transceiver, and the like.

First device 102 may include, for example, at least one input/output 132. Input/output 132 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 132 may include an operatively configured display, speaker, keyboard, keypad, mouse, trackball, touch screen, microphone, data port, etc.

In certain implementations, for example, input/output device 132 may represent one or more display devices and at least one operatively coupled user input device, wherein the display device may be adapted to present a graphical user interface (GUI) or the like capable of presenting at least portions of selected electronic mail messages in a specified order and wherein the presentation and/or user input device may be monitored to determine at least one non-selective user engagement parameter and/or receive at least one user selective input relating to the presented data.

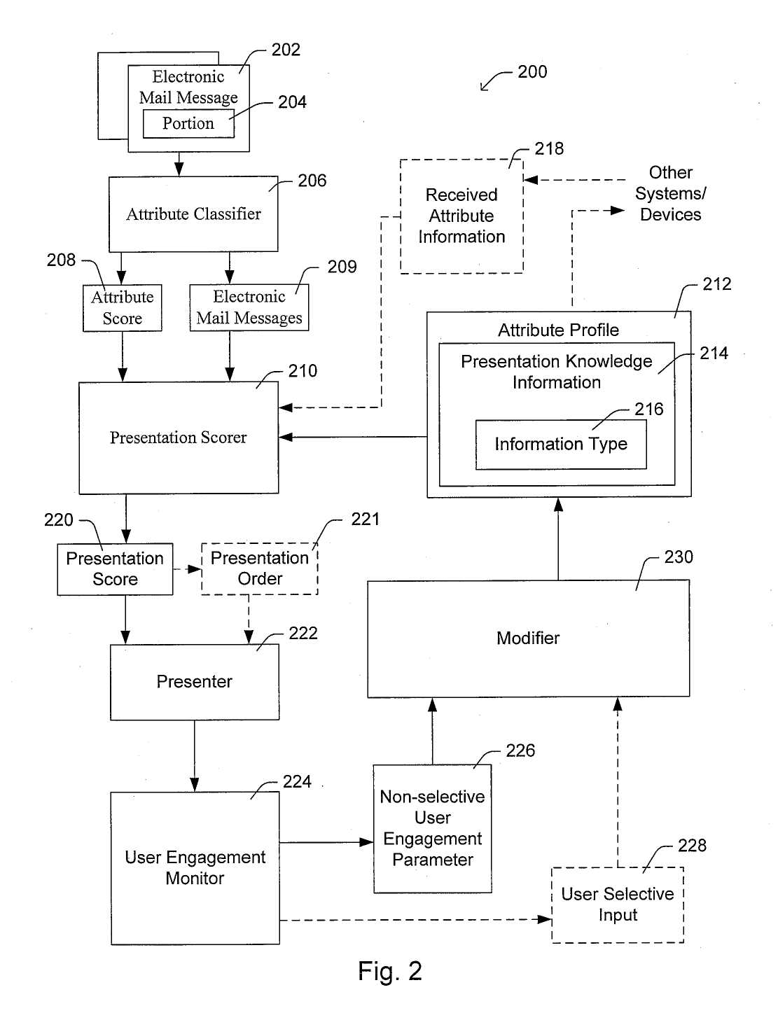

Reference is now made to FIG. 2, which is a block diagram illustrating exemplary functions/features of a portion of an electronic mail message processing and/or handling system 200 that may, for example, be implemented using one or more devices such as shown in FIG. 1.

In system 200, electronic mail messages 202 and/or or at least a portion 204 thereof may be accessed by or otherwise made available to at least one attribute classifier 206. Attribute classifier 206 is adapted to process electronic mail messages 202 and/or portions 204 thereof to classify at least a portion of the electronic mail messages 209 as having a common attribute.

By way of example but not limitation, the electronic mail messages may be classified by attribute classifier 206 as being “spam messages”. As used herein, the term “spam messages” is meant to broadly represent any electronic mail message that may be classified in some manner as being of a type of electronic mail message that a user or entity may decide is undesired or otherwise unwanted. For example, an electronic mail message may be classified as a spam message if it is deemed to be or otherwise include unwanted content (e.g., content that may be pornographic, lewd, fraudulent, etc.), an unsolicited bulk electronic mail message, an unsolicited commercial electronic mail message, an electronic mail message wherein the source or sender's identity may be corrupted, indeterminable, forged, and/or otherwise placed under scrutiny or suspicion (e.g., electronic mail messages sent though unprotected servers, etc). Attribute classifier 206 in FIG. 2 may, for example, include or otherwise be adapted for use with one or more commercially available spam classifiers, filters or the like.

As shown, attribute classifier 206 may provide an attribute score 208 for each electronic mail message. Attribute score 208 may, for example, relate a confidence, ranking or other like information associated with the attribute classification process. Thus, for example, an electronic mail message deemed to be a spam message may have an attribute score that relates to a confidence level between 0 (lacking confidence) and 1 (significant confidence).

The electronic mail messages 209 that are classified as having a common attribute by classifier 206 may be provided to or otherwise identified to a presentation scorer 210. Attribute scores 208, if available/applicable may also be provided to or otherwise identified to presentation scorer 210.

Presentation scorer 210 may also access or otherwise be provided with an attribute profile 212. Attribute profile 212 may, for example, include presentation knowledge information 214. Presentation knowledge information 214 may, for example, be associated with or otherwise include one or more information types 216. Information types 216 may, for example, correspond to information types represented by portions 204 in electronic mail messages 202 and 209.

In certain implementations, all or part of attribute profile 212 may be provided or otherwise made available to one or more other like systems and/or devices, for example, to provide or otherwise be used in providing received attribute information for one or more other like systems and/or devices.

In certain implementations, presentation scorer 210 may also access or otherwise be provided with received attribute information 218. Received attribute information 218 may, for example, be provided by or otherwise associated with one or more other (e.g., remote) processes and/or systems similar to system 200. Received attribute information may, for example, be of similar content and/or type as the information provided in attribute profile 212.

Presentation scorer 210 may be adapted to establish a presentation score 220 for each electronic mail message 209 and/or to otherwise establish a presentation order 221 associated with the electronic mail messages 209 classified by attribute classifier 206. Presentation order 221 may be based, for example, on an ascending or descending numerical or other like order of presentation scores. In certain implementations presentation scorer 210 may, for example, establish presentation scores 220 and/or establish a presentation order 221 based, at least in part, on attribute scores 208 and attribute profile 212. In other implementations, presentation scorer 210 may, for example, establish presentation scores 220 and/or establish a presentation order 221 based, at least in part, on attribute scores 208, attribute profile 212 and/or received attribute information 218.

The presentation scores 220 and/or presentation order 221 may be accessed or otherwise provided to a presenter 222. Presenter 222 may also access and/or otherwise be provided with electronic mail messages 209 and/or at least portions 204 thereof. Here, for example, portions 204 may include one or more identifiers associated with the electronic mail messages. By way of example but not limitation, a portion 204 for an electronic mail message may include a title or subject, the name or identity of the sender or source, and/or other like information.

Presenter 222 may be adapted to present at least two electronic mail messages 209 and/or associated identifiers through a display for a user, e.g., using one or more input/output devices. Presenter 222 may be adapted to list or otherwise visually arrange the presented electronic mail messages and/or identifiers (data and/or representative icon) based, at least in part, on presentation scores 220 and/or presentation order 221. For example, presenter 222 may initiate a display of a list the identifiers of spam messages in a table or other like format based on a presentation score such that those that may be of greater interest to the user might appear at or near the top of the list and/or presented in some other manner intended to raise the attention of the user.

Presenter 222 may, for example, be adapted to allow a user to engage with the presented information using one or more user input devices. Thus, for example, in certain implementations presenter 222 may provide or otherwise operatively couple with graphical user interface or other like capability that allows the user to engage in some manner with the presented/displayed information. Such user engagement may, for example, include non-selective user engagement and/or user selective input.

A user engagement monitor 224 is provided to determine the user engagement with the presented/displayed information by presenter 222. User engagement monitor 224 may, for example, determine at least one non-selective user engagement parameter 226 associated with at least one electronic mail message 209.

By way of example but not limitation, non-selective user engagement parameter 226 may include a non-selective pointer position engagement parameter, a non-selective pointer time engagement parameter, a non-selective induced-action engagement parameter, an engagement presentation time parameter, an engagement presentation scroll parameter, a non-selective engagement search parameter, and/or the like. Such a non-selective user engagement parameter 226 may, for example, be indicative of a user's interest and/or disinterest in the related presented/displayed information.

For example, a non-selective pointer position engagement parameter may represent a measurement of a pointer position associated with a user input device (e.g., mouse, trackball, etc.) with respect to a presented/displayed identifier for a spam message. Thus, for example, such measurement may record in some manner whether the user directed the pointer over, across or sufficiently near the identifier. Similarly, for example, a non-selective pointer time engagement parameter may represent a measurement of an amount of time (e.g., accumulative, etc.) that such pointer position was over, across or sufficiently near the identifier, and/or sufficiently away from such identifier. Further, an engagement presentation time parameter may, for example, be associated with an amount of time that the pointer position was within a displayed window or other graphic user interface feature through which identifiers are presented. Such measurements may relate to potential interest or disinterest for similar electronic mail messages.

For example, a non-selective induced-action engagement parameter may record in some manner that the pointer position with regard to the identifier induced or otherwise initiated a change in the displayed identifier and/or display feature associated therewith out actual user selective input, such as, for example, a tip-tool or other like pop up message, a data field expansion, a highlight or other like passive indication based on the user controlled pointer “hovering” over an indicator. Such induced change of the display may relate to potential interest and/or lack of such induced change may relate to potential disinterest for such electronic mail messages.

For example, an engagement presentation scroll parameter may represent a measurement of potential interest or disinterest for one or more like electronic mail messages based on user scrolling action within a related display window or other like feature associated with all of the presented/displayed information and/or individual presented/displayed identifiers or electronic mail messages.

For example, a non-selective engagement search parameter may represent a measurement of potential interest or disinterest for one or more electronic mail messages if the identifier of an electronic mail message and/or other portion of the electronic mail message was identified in one or more searches initiated by the user.

In certain implementations, user engagement monitor 224 may, for example, also determine at least one user selective input 228 associated with at least one electronic mail message 209. Here, for example, a mouse click and/or other active selection may expressly relate to potential interest or disinterest for a electronic mail message and/or other similar electronic mail messages. For example, a user may provide selective input that expressly verifies whether an electronic mail message classified as a spam message is indeed “spam” to the user. For example, a user may open/read a spam message which may indicate a potential interest for such or similar messages. To the contrary, a user may delete a spam message without opening/reading it, which may indicate a potential disinterest for such or similar messages.

Non-selective user engagement parameter 226 and, optionally user selective input 228, may be provided to a modifier 230. Modifier 230 may be adapted to maintain (e.g., establish, remove, modify, share, etc.) all or part of the information in attribute profile 212. In certain implementations, for example, modifier 230 may provide a learning or feedback capability that allows for adjustment or refinement of presentation knowledge information 214 based on the monitored user engagement of the presented/displayed information and/or received attribute information.

Modifier 230 may, for example, maintain at least one information type 216 within presentation knowledge information 214. By way of example but not limitation, information type 216 may include one or more of source information, author information, recipient information, routing information, title information, subject information, time information, size information, related file information, flag information, data object information, format information, content information, and metadata information. Such information may be found, for example, in one or more portions 204 of an electronic mail message 202. As such, presentation scorer 210 may consider such information in a data message as possibly being of interest or disinterest based on presentation knowledge information 214.

For example, the presentation score 220 and/or presentation order 221 associated with a spam message may be adjusted or otherwise affected if it has a portion 204 that matches or is in some manner determined by presentation scorer 210 to be related to information type 216 in the presentation knowledge information 214. Here, for example, if portion 204 of a spam message 209 includes a sender's address that also appears in an information type 216 as being of potential interest to the user (e.g., based on the historical/learning feedback of non-selective user engagement parameter 226 and/or user selective input 228) then resulting presentation score 220 and/or presentation order 221 may be changed to reflect such potential interest.

Thus, for example, an electronic mail message deemed to be a spam message having an attribute score that relates to a confidence level of 1 (significant confidence) may end up with a corresponding presentation score that allows the related message identifier to appear at or nearer to the top of the presentation order since the user may have potential interest in such a spam message.

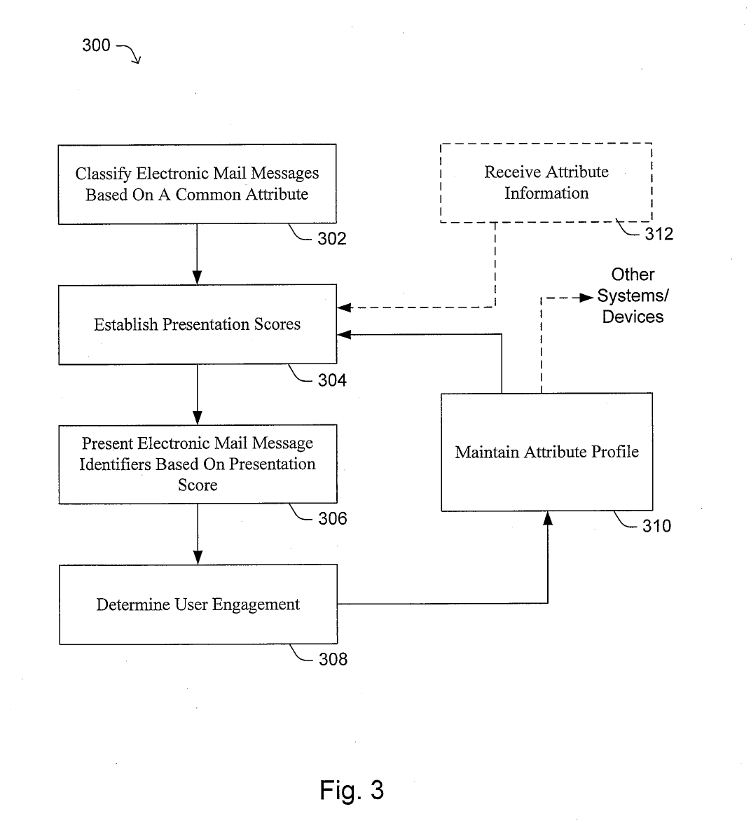

Attention is drawn next to FIG. 3, which is a flow diagram illustrating an exemplary method 300 for use in processing and/or handling electronic mail messages that may, for example, be implemented using one or more devices such as shown in FIG. 1.

At block 302, electronic mail messages are classified based on a common attribute. At block 304, presentation scores are established, possibly based, at least in part, on an attribute profile and/or received attribute information. At block 306, at least a portion of the electronic mail messages classified at block 302 are presented. The presentation at block 306 may include the presentation of a portion of an electronic mail message, such as an identifier or other portion(s) of the electronic mail message. At block 308, user engagement with regard to at least a portion of the presented information at block 306 is determined. At block 310, an attribute profile is maintained based, at least in part, on the determined user engagement. As illustrated, at block 310 all of part of the maintained attribute profile may, for example, be provided or otherwise made accessible to one or more other systems and/or devices. At block 312, attribute information from one or more other like systems and/or devices may be received and provided, for example, to block 304. The received attribute information may also and/or otherwise be used at block 310 to maintain the attribute profile.

In certain implementations, for example, block 304 may include establishing a presentation score 220 (FIG. 2) for each of a plurality of electronic mail messages 209 identified as sharing at least one common attribute, based, at least in part, on presentation knowledge information 214 associated with an attribute profile 212. Block 306 may include, for example, initiating presentation of at least a plurality of identifiers 204 associated with at least a portion of the plurality of electronic mail messages 209 in an order based, at least in part, on the presentation scores 220 of the portion of the plurality of electronic mail messages 209. Block 308 may include, for example, determining at least one non-selective user engagement parameter 226 with regard to at least one of the presented identifiers 204. Block 310 may include, for example, modifying the attribute profile 212 based, at least in part, on the non-selective user engagement parameter 226.

In certain implementations, the common attribute classifies the plurality of electronic mail messages as spam messages. Thus, for example, in certain implementations block 302 may include classifying the plurality of electronic mail messages 209 as spam messages.

In certain implementations, block 304 may include establishing the presentation score 220 based, at least in part, on an attribute score 208 associated with a given electronic mail message.

In certain implementations, for example, block 308 may include receiving at least one user selective input 228 with regard to at least one of the presented identifiers, and/or block 310 may include modifying the attribute profile 212 based, at least in part, on the user selective input 228. Here, for example, block 304 may include establishing a presentation score 220 based, at least in part, on the received attribute information.

In certain implementations, blocks 304 and/or 306 may include, for example, initiating an updated or new presentation of at least the plurality of identifiers in a different order based, at least in part, on at least one modified presentation score 220 resulting from modifying the attribute profile at block 310.

In certain implementations, block 304 may include comparing information in at least a portion 204 of the electronic mail message 209 with the presentation knowledge information 214 and based, at least in part, thereon establishing the presentation score 220.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
for each of a plurality of electronic mail messages identified as sharing at least one common attribute, establishing a presentation score based, at least in part, on presentation knowledge information associated with an attribute profile;
initiating presentation of at least a plurality of identifiers associated with at least a portion of said plurality of electronic mail messages in an order based, at least in part, on said presentation scores of said portion of said plurality of electronic mail messages;
determining at least one non-selective user engagement parameter with regard to at least one of said presented identifiers; and
modifying said attribute profile based, at least in part, on said non-selective user engagement parameter.

2. The method as recited in claim 2, wherein said common attribute classifies said plurality of electronic mail messages as spam messages.

3. The method as recited in claim 1, further comprising classifying said plurality of electronic mail messages as spam messages.

4. The method as recited in claim 1, wherein for each of said plurality of electronic mail messages, establishing said presentation score comprises establishing said presentation score based, at least in part, on an attribute score associated with said electronic mail message.

5. The method as recited in claim 4, further comprising:
receiving at least one user selective input with regard to at least one other of said presented identifiers; and
modifying said attribute profile based, at least in part, on said user selective input.

6. The method as recited in claim 1, wherein said at least one non-selective user engagement parameter is comprises at least one non-selective user engagement parameter selected from a group of non-selective user engagement parameter comprising a non-selective pointer position engagement parameter, a non-selective pointer time engagement parameter, a non-selective induced-action engagement parameter, an engagement presentation time parameter, an engagement presentation scroll parameter, and a non-selective engagement search parameter.

7. The method as recited in claim 1, further comprising:
initiating presentation of at least said plurality of identifiers in a different order based, at least in part, on at least one modified presentation score resulting from modifying said attribute profile.

8. The method as recited in claim 1, wherein establishing said presentation score based, at least in part, on said presentation knowledge information comprises comparing information in at least a portion of said electronic mail message with said presentation knowledge information and based, at least in part, thereon establishing said presentation score.

9. The method as recited in claim 1, wherein said presentation knowledge information comprises at least one type of information selected from a group of different types of information comprising source information, author information, recipient information, routing information, title information, subject information, time information, size information, related file information, flag information, data object information, format information, content information, and metadata information.

10. The method as recited in claim 1, wherein for each of said plurality of electronic mail messages, establishing said presentation score comprises establishing said presentation score based, at least in part, on received attribute information regarding said electronic mail message.

11. The method as recited in claim 1, further comprising:
providing at least a portion of said attribute profile to a network.

12. A system comprising:
at least one computing platform adapted to:
access a plurality of electronic mail messages and for each of said plurality of electronic mail messages identified as sharing at least one common attribute, establish a presentation score based, at least in part, on presentation knowledge information associated with an attribute profile,
initiate presentation of at least a plurality of identifiers associated with at least a portion of said plurality of electronic mail messages in an order based, at least in part, on said presentation scores of said portion of said plurality of electronic mail messages,
determine at least one non-selective user engagement parameter with regard to at least one of said presented identifiers, and
modify said attribute profile based, at least in part, on said non-selective user engagement parameter.

13. The system as recited in claim 12, wherein said common attribute classifies said plurality of electronic mail messages as spam messages.

14. The system as recited in claim 12, wherein for each of said plurality of electronic mail messages, said at least one computing platform is adapted to establish said presentation score based, at least in part, on an attribute score associated with said electronic mail message.

15. The system as recited in claim 12, wherein said at least one non-selective user engagement parameter is comprises at least one non-selective user engagement parameter selected from a group of non-selective user engagement parameter comprising a non-selective pointer position engagement parameter, a non-selective pointer time engagement parameter, a non-selective induced-action engagement parameter, an engagement presentation time parameter, an engagement presentation scroll parameter, and a non-selective engagement search parameter.

16. The system as recited in claim 12, wherein said at least one computing platform is further adapted to compare information in at least a portion of said electronic mail message with said presentation knowledge information and based, at least in part, thereon establish said presentation score.

17. The system as recited in claim 12, and wherein said presentation knowledge information comprises at least one type of information selected from a group of different types of information comprising source information, author information, recipient information, routing information, title information, subject information, time information, size information, related file information, flag information, data object information, format information, content information, and metadata information.

18. The system as recited in claim 12, further comprising:
at least one other computing platform operatively coupled to said at least one computing platform, and
wherein for each of said plurality of electronic mail messages, said at least one computing platform is adapted to establish said presentation score based, at least in part, on received attribute information from said at least one other computing platform regarding said electronic mail message.

19. A computer program product, comprising computer-readable medium comprising instructions for causing at least one processing unit to:
access a plurality of electronic mail messages and for each of said plurality of electronic mail messages identified as sharing at least one common attribute, establish a presentation score based, at least in part, on presentation knowledge information associated with an attribute profile,
initiate presentation of at least a plurality of identifiers associated with at least a portion of said plurality of electronic mail messages in an order based, at least in part, on said presentation scores of said portion of said plurality of electronic mail messages,
determine at least one non-selective user engagement parameter with regard to at least one of said presented identifiers, and
modify said attribute profile based, at least in part, on said non-selective user engagement parameter.

20. The computer program product as recited in claim 19, wherein said common attribute classifies said plurality of electronic mail messages as spam messages.

21. The computer program product as recited in claim 19, wherein for each of said plurality of electronic mail messages, said computer-readable medium comprising instructions for causing said at least one processing unit to establish said presentation score based, at least in part, on an attribute score associated with said electronic mail message.

22. The computer program product as recited in claim 19, said computer-readable medium comprising instructions for causing said at least one processing unit to compare information in at least a portion of said electronic mail message with said presentation knowledge information and based, at least in part, thereon establish said presentation score.

23. The computer program product as recited in claim 19, wherein for each of said plurality of electronic mail messages, said computer-readable medium comprising instructions for causing said at least one processing unit to establish said presentation score based, at least in part, on received attribute information regarding said electronic mail message.

24. An apparatus comprising:
means for establishing a presentation score, for each of a plurality of electronic mail messages identified as sharing at least one common attribute, based, at least in part, on presentation knowledge information associated with an attribute profile;
means for presenting of at least a plurality of identifiers associated with at least a portion of said plurality of electronic mail messages in an order based, at least in part, on said presentation scores of said portion of said plurality of electronic mail messages;
means for determining at least one non-selective user engagement parameter with regard to at least one of said presented identifiers; and
means for modifying said attribute profile based, at least in part, on said non-selective user engagement parameter.

25. The apparatus as recited in claim 24, wherein said common attribute classifies said plurality of electronic mail messages as spam messages.
